(19) United States
(12) Patent Application Publication
(10) Pub. No.: US 2013/0346247 A1
(43) Pub. Date: Dec. 26, 2013

(54) Recommending Options Based on Sustainability Metrics

(71) Applicants: Cullen E. Bash, Los Gatos, CA (US); Yuan Chen, Sunnyvale, CA (US); Kiara Groves Corrigan, Burlingame, CA (US); Daniel Juergen Gmach, Palo Alto, CA (US); Dejan S. Milojicic, Palo Alto, CA (US); Amip J. Shah, Santa Clara, CA (US)

(72) Inventors: Cullen E. Bash, Los Gatos, CA (US); Yuan Chen, Sunnyvale, CA (US); Kiara Groves Corrigan, Burlingame, CA (US); Daniel Juergen Gmach, Palo Alto, CA (US); Dejan S. Milojicic, Palo Alto, CA (US); Amip J. Shah, Santa Clara, CA (US)

(21) Appl. No.: 13/531,075

(22) Filed: Jun. 22, 2012

(51) Int. Cl. G06Q 30/00

(52) U.S. Cl. 705/26.61

(57) ABSTRACT

Recommending options based on sustainability metrics includes identifying multiple end to end service delivery options, each of the end to end service delivery options having a kind of service, an application service provider to provide the kind of service, and a client device; calculating a sustainability value for each of the end to end service delivery options, and recommending one of the end to end service delivery options based on the sustainability value.

### BACKGROUND

When a user desires to use an online service, the user has a number of options from which to choose. For example, the user may wish to send a message to a friend. The user may send the message to the friend over several kinds of service, such as email, instant messengers, blog postings, social networks, or other services. If the user selects to use email, the user may select from different classes of emails to send the message, such as with a client based email service or a web based email service. Further, the user may choose among multiple application service providers that offer email service instances within these classes. The user may select the kind and class of service based on convenience or familiarity with the service.

After selecting a kind of service, class, and application service provider, the user may generate the message with a client device that sends the message over a communication channel to a location that processes the message. The message may be sent over a hardwired network, a wireless network, a satellite, or other communication mechanism. The location may be a data center that houses multiple servers and other devices for processing the email. The data center may store the message or send the message to another location where the friend may access the email at the friend's convenience.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of illustrative end to end service delivery options, according to principles described herein.

FIG. 2 is a diagram of an illustrative end to end service delivery option, according to principles described herein.

FIG. 3 is a diagram of an illustrative display for selecting end to end service delivery options, according to principles described herein.

FIG. 4 is a diagram of an illustrative display, according to principles described herein.

FIG. 5A is a diagram of an illustrative chart of approaches for determining sustainability sub-values, according to principles described herein.

FIG. 5B is a diagram of an illustrative matrix, according to principles described herein.

FIG. 5C is a diagram of an illustrative matrix, according to principles described herein.

FIG. 6 is a diagram of an illustrative method for recommending options, according to principles described herein.

FIG. 7 is a diagram of an illustrative processor, according to principles described herein.

FIG. 8 is a diagram of an illustrative flowchart of a process for determining sustainability values, according to principles described herein.

FIG. 9 is a diagram of an illustrative flowchart of a process for determining sustainability values, according to principles described herein.

FIG. 10 is a diagram of an illustrative flowchart of a process for recommending options, according to principles described herein.

FIG. 11 is a diagram of an illustrative method for recommending options, according to principles described herein.

### DETAILED DESCRIPTION

Users and product developers alike are concerned about the sustainability of products that they buy and produce. Sustainability issues include, but are not limited to, carbon emissions, recycling, energy consumption, and water use. Sustainability is also an increasing concern for internet service providers, as demand for services increase alongside with increases in energy costs, regulatory requirements, and social concerns over greenhouse gas emissions.

Each of the service options may include components that use varying amounts of energy and natural resources. For example, on one end of a service delivery option, a certain amount of natural resources and energy may be used at a data center to just process the requested service. Further, other resources are used to communicate between the data center and the client's device. Also, on another end of the service delivery option, the client device itself consumes energy when delivering the service to the user. Some of the components of each of the end to end service delivery options may be more sustainable than other components. For example, one type of communication mechanism may be more sustainable than another type of communication mechanism for a particular service. Also, some services may consume more energy on different types of client devices as well. Users may desire to factor in how sustainable an entire end to end service delivery option is before choosing a specific service option.

To understand the entire sustainability of each end to end service delivery option, the sustainability of each component of the end to end service delivery option should be determined. These components may include the energy and natural resources consumed at a data center used to process the service, the cost and sustainability of accessing the service, the cost and sustainability of delivering the service, and the cost and sustainability of using the service with the client device.

The present specification describes subject matter including, for example, a method for recommending options based on sustainability metrics. Examples of such a method include identifying multiple end to end service delivery options, calculating a sustainability value for each of the end to end service delivery options, and recommending one of the end to end service delivery options based on the sustainability value. Each of the end to end service delivery options may include a kind of service, an application service provider to provide the kind of service, and a client device.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

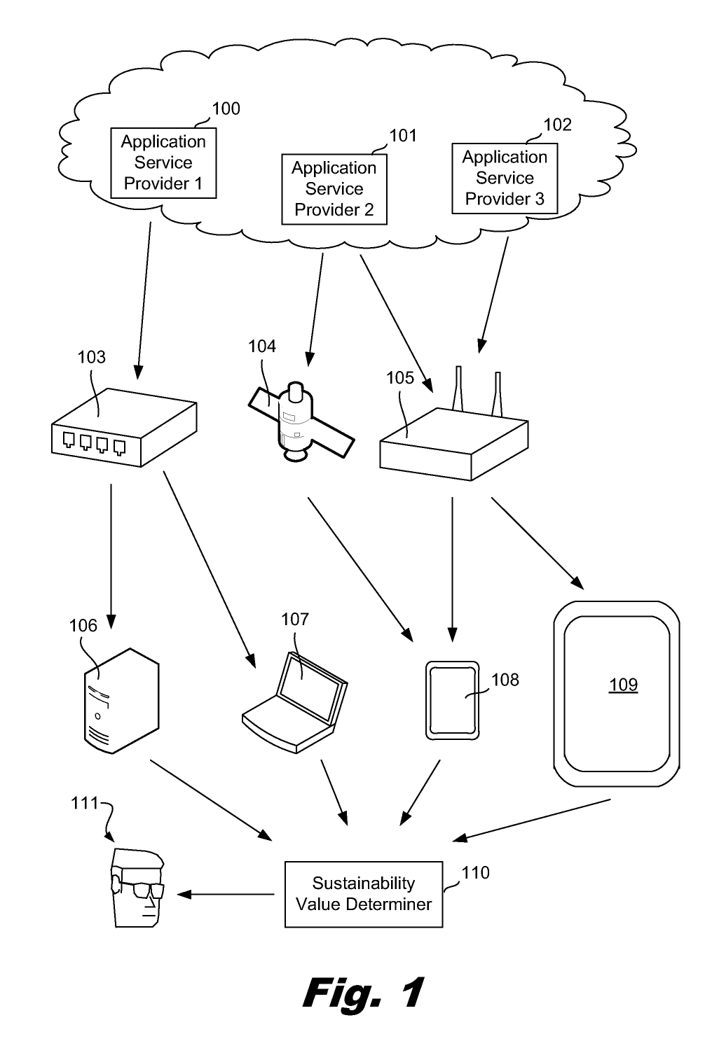

FIG. 1 is a diagram of illustrative end to end service delivery options, according to principles described herein. In this example, multiple application service providers (100, 101, 102) are depicted in communication with multiple communication mechanism devices (103, 104, 105). The application service providers (100, 101, 102) may be operated in data centers or other locations that contain infrastructure such as processors, memory storage, networking components, security devices, power generators, servers, routers, other devices, and combinations thereof. The application service providers (100, 101, 102) may offer specific service instances that include different kinds and classes of services. A non-exhaustive list of service kinds may include email, instant messaging, social networks, blogs, website services, texting, other services, or combinations thereof.

The communication mechanism devices (103, 104, 105) may include hardwired routers (103), satellites (104), wireless routers (105), cell transceivers, other communication mechanism devices, or combinations thereof. The communication mechanism devices (103, 104, 105) may be in communication with client devices (106, 107, 108, 109) that have user interfaces. The user may instruct the application service providers (100, 101, 102) over the communication mechanisms with the client devices (106, 107, 108, 109). The client devices may include desktop computers (106), laptops (107), cell phones (108), electronic tablets (109), other client devices, or combinations thereof.

While the example of FIG. 1 depicts specific application service providers in communication with specific communication mechanisms, any of the service providers may be in communication with any of the communication mechanism devices. Also, while the example of FIG. 1 depicts certain communication mechanism devices in communication with specific client devices, any of the communication mechanism devices may be in communication with any client device. Further, while specific application service providers are depicted with specific communication mechanism devices or client devices, the application service providers may be matched with any suitable communication mechanism device or client device. Further, the options may include multiple application service providers, such as application service providers that depend on another. Further, options may include multiple communication mechanism devices and/or multiple client devices.

Each application service provider, communication mechanism, and client device may use different amounts of power or consume different amounts of natural resources. In addition, they may cause the emission of different types of greenhouse gases, such as a carbon dioxide, during their operation. Further, different amounts of natural resources and energy may be consumed when manufacturing the infrastructure, client devices, communication mechanism devices, or other devices used in the options.

Further, specific infrastructure at specific locations that run different application service providers may be more efficient at processing certain kinds of services. Also, specific communication mechanisms may be more efficient at sending different messages. Also, the infrastructure, communication mechanism devices, and client devices may each have specific idle power consumption rates when these devices are turned on. They may also consume varying amounts of additional computing power when processing the services. As a result, some of the end to end service delivery options are more sustainable than others when all factors are considered.

In the example of FIG. 1, a sustainability value determiner (110) may determine a sustainability value for each of the options from which a user (111) may select. The sustainability value determiner (110) may be part of a processor or other computer program product. The sustainability value may include sustainability sub-values for different components of the different options. For example, a sustainability sub-value may be determined for the infrastructure at the location, the kind of service, the class of service, the application service provider, the communication mechanism, the client device, other components of the option, or combinations thereof. In some examples, the sustainability sub-values include both the sustainability in relation to the idle power consumption, the computing power used by performing the service, or combinations thereof.

In some examples, the sustainability sub-values and overall value are at least in part based on parameters set by the user. For example, the user may select green house gas emissions, power consumption, and water consumption to be included in the sustainability values. In some examples, the user may also select other parameters or select fewer parameters to be included in the sustainability values.

The user (111) may decide which option to use based on the sustainability values determined by the sustainability value determiner (110). In some examples, the sustainability value determiner (110) may also rank the options based on their overall sustainability values and make a recommendation to the user for which option to use. In some examples, the sustainability value determiner (110) may also send a recommendation to an internet service provider. In some examples, the recommendation to the internet service provider includes the same information that is sent to the user or the internet service provider's recommendation may include information more relevant to sustainability from the service provider's perspective.

In some examples, the user requests the sustainability value determiner (110) to select options already available to the user. In other examples, the user uses the sustainability value determiner (110) to help the user determine which online products to download or purchase, which client devices to use or purchase, which communication mechanisms to use, or combinations thereof.

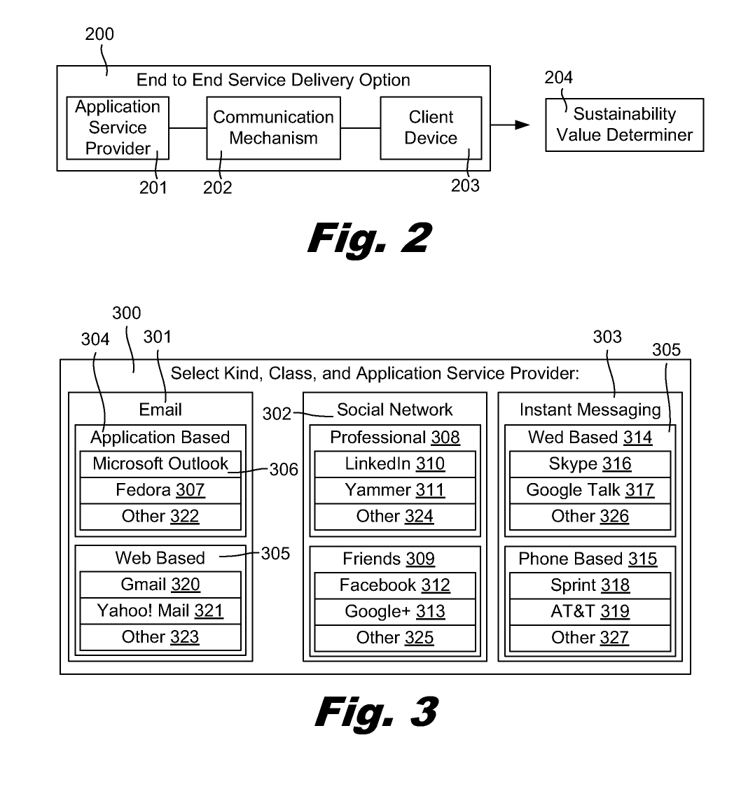

FIG. 2 is a diagram of an illustrative end to end service delivery option (200), according to principles described herein. In this example, the end to end service delivery option (200) includes an application service provider component (201), a communication mechanism component (202), and a client device component (203). Each of the components (201, 202, 203) may have a different sustainability sub-value. A sustainability value determiner (204) may determine a sustainability sub-value for each of the components (201, 202, 203) and combine sub-values to determine an overall sustainability value for the end to end service delivery option (200).

FIG. 3 is a diagram of an illustrative display (300) for selecting end to end service delivery options, according to principles described herein. In this example, a program allows a user to select different kinds of services, different classes within those kinds of services, and application service providers.

In this example, a user selects different kinds of services to send a message to a friend. In this example, the display (300) gives the user three kinds of services to select that include email (301), social network (302), and instant messaging (303). Under email (301), the display (300) gives the user two classes of options that include application based email (304) and web based email (305). Under the application based email class (304), the display (300) gives the user application service provider options that may include using Microsoft Outlook (306), Fedora (307), and other application service providers (322). Microsoft Outlook is available through Microsoft Corporation headquartered in Redmond, Wash. Fedora is available through Red Hat, Inc. headquartered in Raleigh, N.C. Under the web based email class (305), the display (300) gives the user application service provider options that may include using Gmail (320), Yahoo! Mail (321), and other application service providers (323). Gmail is available through Google, Inc. headquartered in Mountain View, Calif. Yahoo! Mail is available through Yahoo! Inc., which is headquartered in Sunnyvale, Calif.

Under social networks (302), the user has two social network class options that include professional social networks (308) and friend social networks (309). Under professional social networks (308), the display (300) gives the user application service provider options that may include using LinkedIn (310), Yammer (311), and other application service providers (324). LinkedIn is available through the LinkedIn Corporation, which is headquartered in Mountain View, Calif. Yammer is available through Yammer, Inc., which is headquartered in San Francisco, Calif. Under the friend social networks (309), the display (300) gives the user application service provider options that may include Facebook (312), Google+ (313), and other application service providers (325). Facebook is available through Facebook, Inc., which is headquartered in Menlo Park, Calif. Google+ is available through Google, Inc. headquartered in Mountain View, Calif. Another service application provider that may be used is Twitter, which is provided by Twitter, Inc. headquartered in San Francisco, Calif.

Under instant messaging (303), the user has two instant messaging class options that include a web based class (314) and a phone based class (315). Under the web based class (314), the display (300) gives the user application service provider options that may include using Skype (316), Google Talk (317), and other application service providers (326). Skype is available through the Microsoft Corporation headquartered in Redmond, Wash. Google Talk is available through Google, Inc. headquartered in Mountain View, Calif. Under the phone based class (315), the display (300) gives the user application service provider options that may include Sprint (318), AT&T (319), and other application service providers (327). Sprint is available through Sprint Nextel Corporation, which is headquartered in Overland Park, Kans. AT&T is available through AT&T, Inc., which is headquartered in Dallas, Tex.

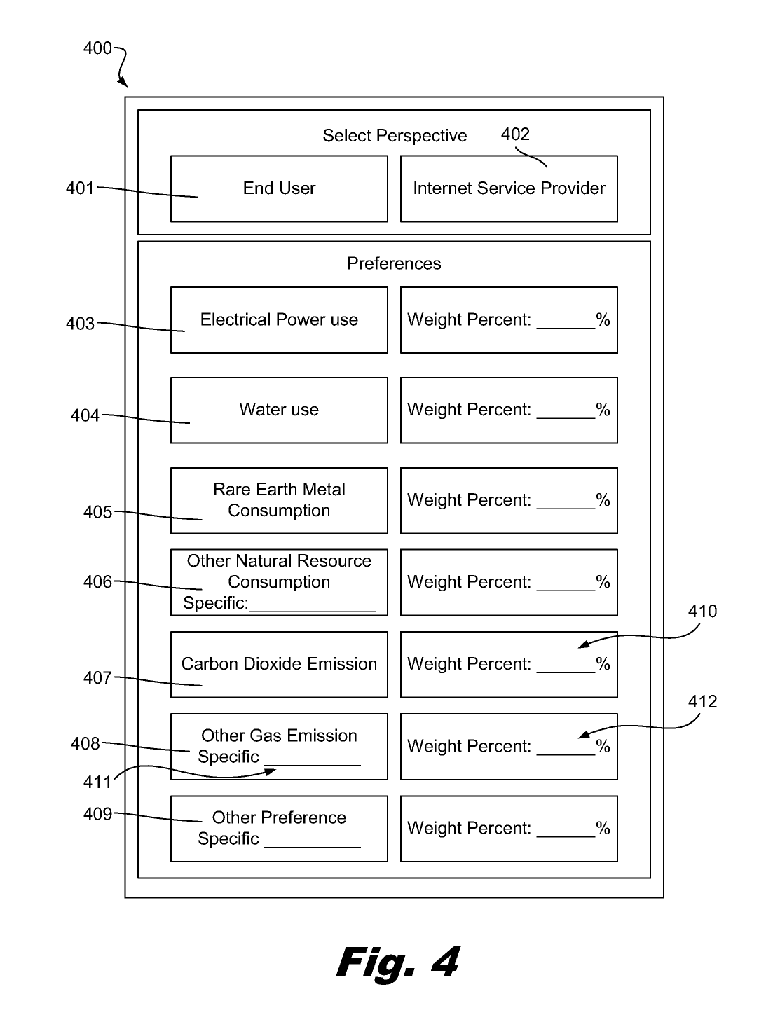

FIG. 4 is a diagram of an illustrative display (400), according to principles described herein. In this example, the display (400) gives the option of selecting a perspective of either an end user (401) or an internet service provider (402). The internet service provider may desire to weight the sustainability values differently than the end user. For example, the end user may be less concerned by certain sustainability issues that are discussed in the media, but the internet service provider may be concerned about these issues to avoid negative publicity. In another example, the internet service provider is located in an area where a particular natural resource is plentiful, like water, and is less concerned about that resource's conservation. In another example, the internet service provider is less concerned about the sustainability sub-values of the client device because the client devices influence the internet service provider's cost indirectly, where the end consumer may be more concerned about the client devices because they are directly impacted by the client device's cost.

In FIG. 4, the display (400) gives options to select preferences and to weight each preference. A non-exhaustive list of preferences include an electrical power use preference (403), a water use preference (404), a rare earth metal consumption preference (405), other natural resource consumption preference (406), carbon dioxide emission preference (407), other gas emission preference (408), resource use preference, gas use preference, raw metal consumption preference, mineral consumption preference, conflict mineral consumption preference; emissions preference, greenhouse gas emissions preference, ozone depletion agents emissions preference, sulfur dioxide emissions preference, air pollutant emissions preference, particulate emissions preference; toxic effluents emissions preference, land use, other preferences (409), and combinations thereof. Of the preferences selected, a preference weight may be selected. For example, if a user is just concerned about carbon dioxide emissions, the user may select the carbon dioxide emission preference (407) and enter “100” into the weight percent field (410) associated with that preference. In another example, the user is mostly concerned about carbon dioxide emissions and is concerned to a lesser degree about other greenhouse gas emissions. In such an example, the user may select the carbon dioxide emission preference (407) and enter, for example, “75” into the weight percent field (410) associated with that preference. In the same example, the user may select the other gas emission preference (408), input a greenhouse gas or multiple green house gases in the selection field (411), and input a “25” into the weight percent field (412) associated with the other gas emission preference (408).

In some examples, the user or internet service provider also has an option to weight the sub-values for each of the end to end service delivery option components. For example, the user may desire to give a greater weight to the sustainability of his client device than to the infrastructure used to run the application service provider's service instance.

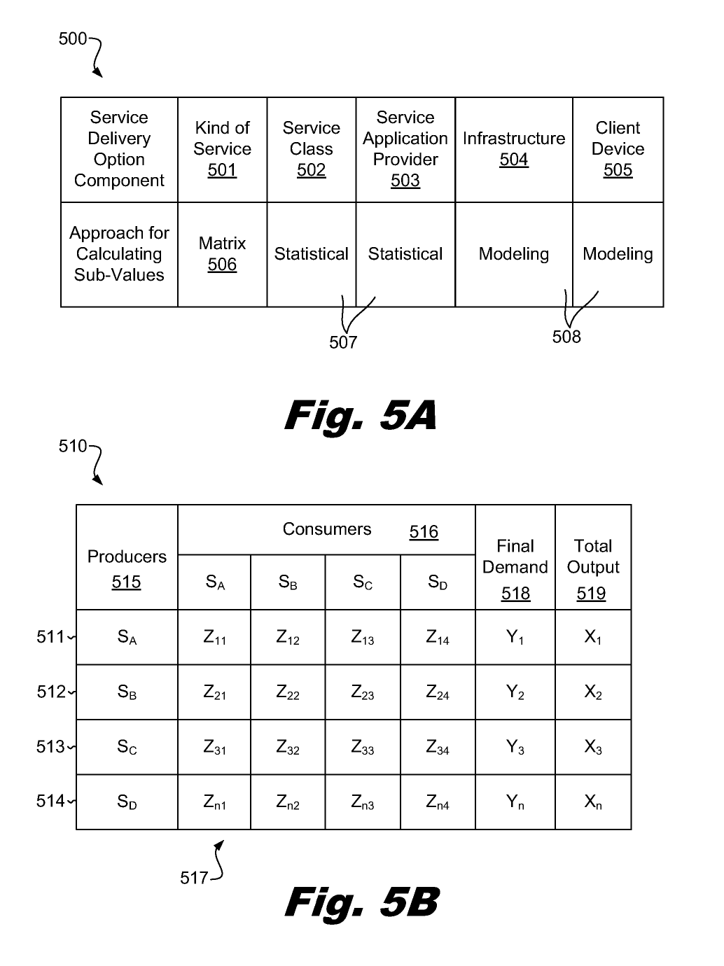

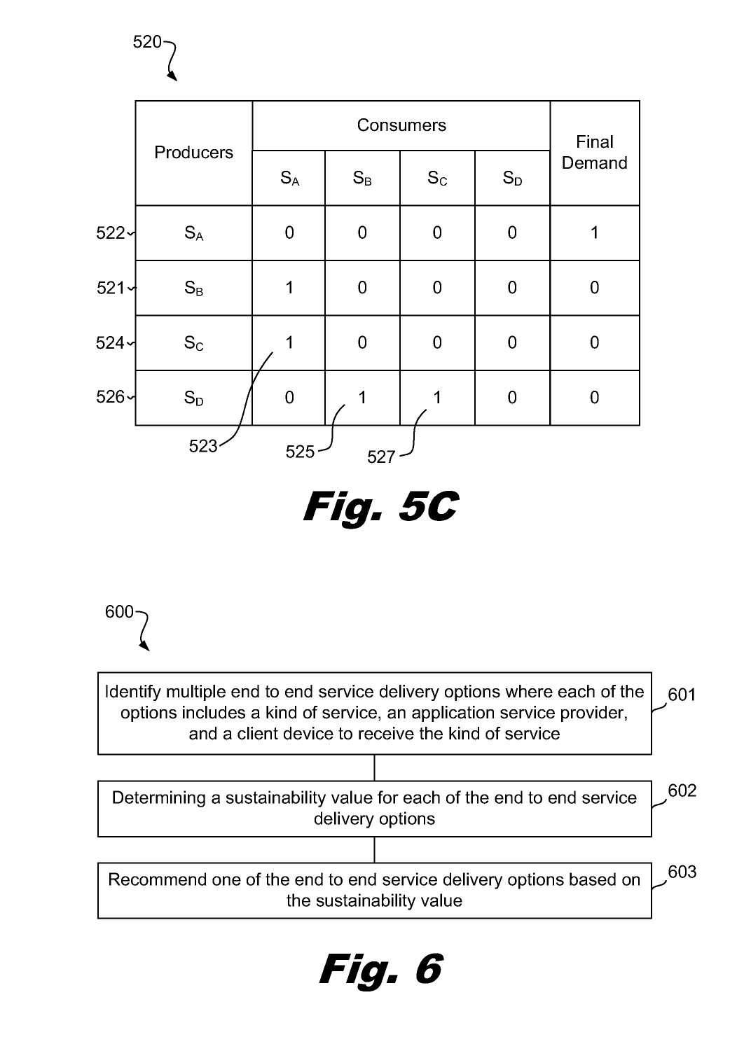

FIG. 5A is a diagram of an illustrative chart (500) of approaches for determining sustainability sub-values, according to principles described herein. In this example, the chart (500) includes several components of an end to end service delivery option. In FIG. 5A, the components include a kind of service component (501), a service class component (502), a service application provider component (503), an infrastructure component (504), and a client device component (505).

Different approaches may be used to determine the sustainability sub-value for each component. In the example of FIG. 5A, a matrix approach (506) may be used to determine the sustainability sub-value of the kind of service component (501), a statistical approach (507) may be used to determine the sustainability sub-value of the service class component (502) and the service application provider component (503), and a modeling approach (508) may be used to determine the sustainability sub-value of the infrastructure component (504) and the client device component (505).

### Modeling Approach

The modeling approach may include the use of models to determine the power consumption of tangible devices such as client devices, communication mechanism devices, infrastructure devices, server devices, router devices, storage devices, other devices, or combinations thereof. A model may be a function that takes inputs to produce outputs that may calculate or become a sub-value of a component of an end to end service delivery option.

Different services may utilize different service topologies. For example, a single device, such as a server, may be dedicated to performing a single service. In other examples, multiple devices may be dedicated to providing a single service. Further, a single device may be dedicated to providing multiple services or at least a part of at least one service. In other examples, multiple devices process just part of a service. In some examples, to complete a service, a device may request additional services of at least another device. In some examples multiple devices and multiple services are needed to execute a service requested by a user.

Power consumption of tangible devices may be separated into two parts. One part may be idle power, such as the power usage when the server is idle. The ideal power consumption may be determined based on the device's configuration, such as processor model, number of processors and speed, memory type and size, network interface cards, power supply, other configurations, or combinations thereof. Another part may be dynamic power, which can be determined based on the activities of the device, such as central processor unit (CPU) utilization.

While dynamic power may be affected by other resources, the device's CPU is often the main contributor to the dynamic power. Models may account for both direct and indirect CPU usage for an online service. The indirect CPU usage is mainly the energy consumed with processing on behalf of the service. While the direct CPU usage can be obtained for a service from monitoring data, the service's CPU consumption may also be estimated based on the contribution of processing, using the percentage of packets sent/received for the service. The actual CPU usage charged to a service may be estimated using model (1) below:

uᵢ=ūᵢ+(nᵢ/n)uₒ Model (1)

In Model (1), uₒ is the CPU utilization, n is the number of total packets processed by the physical server, and nᵢ is the number of packets contributed to the service. Accordingly, power usage can be measured and divided as dynamic power usage, based on overall CPU utilization.

The physical server idle power consumption may be proportionally allocated to a service based on CPU usage and allocated memory sizes. In some examples, a service's power consumption can be calculated using Model (2).

Pᵢ=(Pₛ−P_{idle})*uᵢ+(P_{idle}−P_{memory})*(uᵢ/Σ_{jε}_{^{J}}uⱼ)+P_{memory}*(Mᵢ/Σⱼₒ_{^{J}}Mⱼ) Model (2)

In Model (2), J is the set of virtual machines running on the server, Uᵢ is the CPU usage for a service i, Mᵢ is the amount of memory allocated to the service, Ps is the actual power consumption of the physical server. P_{idle} is the idle power of a physical server, and P_{memory} is the portion of idle power contributed by the memory. Idle physical power and memory power consumption values may be determined based on the server specification or management tools.

In some examples, there are multiple transaction types in a service. For example, an online e-business application has transaction types such as login, browse, checkout, or other transaction types. During a certain time period, a component's resource usage may be the sum of the demand of all transaction types. Hence, the resource consumption of a service component may be determined using a linear function of the transaction mix, for example, according to Model (3):

$${u}_{i} = {\sum }_{n = 1}^{n} • {a}_{n} {λ}_{n} \qquad Model ( 3 )$$

In Model (3), n is number of unique transaction types, λₙ (n=1 . . . N) is the request rate of transaction type n during a time interval, and αₙ is the resource usage of transaction type n (e.g. per-transaction-type resource usage). Statistics for different transaction types or user requests are readily available from regular application monitoring. The model parameters αₙ may be identified using linear regression over multiple measurement intervals.

After a resource usage for the service components is determined, the power model shown in Model (2) may be used to apportion the physical server power consumption to the component. To estimate the power consumption of a service, configuration and topology information of the service may be extracted to discover which activities belong to the service, and which tangible devices the service is using.

For an activity that is performed on a dedicated server, the power consumption is the full power usage of the physical server and may be obtained directly. For activities that are performed on servers that also use resources for other services, a resource usage model, such as Model (1) can be used to estimate resource usage.

After obtaining the resource usage for each activity, a power model, such as Model (2) may be used to obtain the component level power consumption. Finally, each activity's power consumption can be aggregated to obtain the service's power consumption, as shown by Model (4).

$$P = {\sum }_{i = 1}^{m} • {P}_{i} \qquad Model ( 4 )$$

In Model (4), M is the number of service components, and Pᵢ is the power usage of service component i.

In some examples, the utilization of one service results in the utilization of multiple services, which may be accounted for in the sustainability value. For example, an incoming request may be processed by a service itself, and the service may then pass or generate one or multiple requests to other services. These requests may also result in the creation of additional requests to additional services and so on. The replies may be sent back in reverse order. When a service receives replies from other services, the service may process the replies and send the results back to the requesting service. The results are processed by the first service that the client directly interacts with, and a final reply is sent back by the first service to the client. Such a service dependency can be modeled as a direct acyclic graph (DAG).

When the service has been characterized, the analysis may determine power usage. The power usage may include both direct and indirect power usage. In an example, the direct power usage of a service may include local processing and indirect power usage from other services that process requests originating from the service. One of the models described above can also be used to determine the direct power consumption.

To determine indirect power consumption, the service dependency information may be obtained, and a DAG may be generated. For each service on the service chain (except the original service), the power usage may be calculated by those requests from the original service (directly or indirectly). The resource usage of requests may be estimated using a resource usage model such as Model (3). Then the direct power usage of a service may be proportionally allocated to the requests from other services to obtain indirect power usage.

In some examples, power usage charged to sub-requests handled by other services is aggregated to obtain the indirect power consumption of the service, as shown by Model (5).

$${P}_{indirect} = {\sum }_{k = 1}^{k} • ( {\dot{u}}_{k} / {u}_{k} ) {P}_{k}^{indirect} \qquad Model ( 5 )$$

In Model (5), K is the number of services on the service chain (e.g., the number of services or sub-requests that the original service relies on), and Uₖ is the portion of resource usage of service K that is contributed by requests from the original service. Also in Model (5), U_{K} is the total resource usage of service K, and Pₖ^{indirect} is the indirect power usage of service K.

After determining the power consumption of a service, the sustainability impact may be determined. The impact on service-level sustainability, such as carbon emission and resource consumption, may depend at least in part on the efficiency of the infrastructure. For example, water and electricity consumption may depend on the cooling and power infrastructure of the data center. In some examples, the sustainability impact may be highly dependent on these efficiencies or a lack thereof.

In some examples, power consumption efficiencies are indicated by a power usage efficiency (PUE) metric. A PUE of 1.5 may indicate that for each watt used by data center equipment, an additional half watt is used for a task, such as cooling, power distribution, or other task. Thus, using the data center PUE, the total power demand Pₜₒₜₐₗ for a service may be determined by multiplying the power demand P for hosting the service with the data center PUE according to Model (6).

Pₜₒₜₐₗ=P*PUE Model (6)

Carbon emissions may be determined based on a power supply mix for the data center. In some examples, the amount of carbon emission per kilowatt hour (KWh) is determined for each power supply source. The carbon emission per KWh for the power supply mix may be expressed as a weighted average over all power supply sources for the data center, as expressed by Model (7).

CO₂_{_{—}}Per_{—}KWh_{SupplyMix}=Σ_{qεQ}Y_{q}*CO₂_{_{—}}Per_{—}KWh_{q} Model (7)

In Model (7), Q is the set of power supply sources, CO₂_{_{—}}Per_KWh_{SupplyMix} is the amount of carbon emissions for each KWh from supply q, and Y_{q} is the fraction of power from the power supply source with the summation equal to 1. Accordingly, carbon emissions for the service may be expressed by Model (8).

CO₂=Pₜₒₜₐₗ*CO₂_{_{—}}Per_{—}KWh_{SupplyMix} Model (8)

In some examples, if the power mix of the data center or the carbon emissions for the various power sources is unknown, then average numbers for the carbon emissions of power sources, such as for the corresponding region/country, may be used instead.

The water consumption of a service may include both direct and indirect natural resource consumption. For example, direct water consumption may be the water lost at the cooling towers of the data center and may depend at least to some extent on the cooling infrastructure and the amount of cooling needed.

Indirect water consumption may be based on the water consumption at the power generation plant. The average water consumption per KWh for the power supply mix of the data center can be determined with an expression such as Model (7), and then used to determine the indirect water consumption of the service, similar to the determination based on Model (8), above.

The examples described above are provided for purposes of illustration, and are not intended to be limiting. Other devices and/or device configurations may be utilized to carry out the operations described herein. While the examples above have been described with specific models, any models may be used according to the principles described herein.

### Matrix Approach

The matrix approach may include generating a matrix of elements that includes various services and services components related to a service delivery. For example, the matrix of elements may include the services and services components that an organization uses to deliver its services, such as cloud computing, e-mail messaging, or other services. In such an example, the services contained in the matrix elements may include an end service, such as a cloud computing service, for which a user makes a demand. The services may also include other services that are performed to provide the end service. In addition, the services components may include virtual machines and physical machines that are used to provide the services. In some examples, the services and the services components may correspond to a service architecture and/or infrastructure of the service.

In some examples, the determination of which services and services components to include in the matrix may be based upon information gathered from various information sources. For instance, the information may be gathered from publicly available sources, such as the Internet. In another example, the information may be obtained from privately accessible sources, such as a secure server, or from the organizations that provide the services.

In some examples, the services and the services components included in the matrix may include those services and services components for which lower-level metric data is available for the services. In instances where the lower-level metric data is unavailable, the modeling approach described above may be used.

According to an example, to identify the elements to be included in the matrix, a hierarchy of the services and the services components that are used to deliver a particular service may be identified. The hierarchy of the services and the services components may also be based upon information gathered from various information sources.

FIG. 5B shows an illustrative matrix (510) of a services ecosystem composed of matrix elements. As shown therein, the matrix of elements includes service A (S_{A}) (511), service B (S_{B}) (512), service C(S_{C}) (513), and service D (S_{D}) (514). The matrix is also depicted as having a plurality of rows, which correspond to producers (515) of service resources, such as physical machines, virtual machines, or services. In addition, the matrix is depicted as having a plurality of columns, which correspond to consumers (516) of the service resources, which may also include physical machines, virtual machines, or services. In FIG. 5B, if service A is a consumer of service B, then the inter-component relationship between service A and service B will have a value other than zero.

In some examples, each of the producers and the consumers corresponds to respective individual services, if the appropriate lower-level data are available. However, if the appropriate lower-level data are not available, the producers and the consumers may instead be listed as similar representative services or classes of services.

Dependencies between the matrix elements may be determined using initialization data. The matrix (510) described herein may be set up to correspond to the service architecture and infrastructure of the service. The initialization data may include the hierarchy of services and service components that are used to deliver a particular service. The dependencies between the matrix elements are defined as matrix coefficients (zᵢⱼ) (517) in the matrix, which describe inter-component relationships between the elements contained in the matrix's rows and columns. The matrix coefficients (517) may describe dependencies between the elements, which may include services and/or service components with respect to each other. The initialization data used to determine the dependencies may include the hierarchy of the services and the services components that are used to deliver a particular service.

In some examples, when a service demand is made for one unit of service A (511), each unit of service A (511) requires one unit of service B (512) and one unit of service C (513). In this example, a unit of demand may be a request for a particular service. Further, in this example, each unit of service B (512) and service C (513) requires one unit of service D (514). Put differently, for each of two units of service D (514) that will be consumed by service B (512) and service C (513), one unit of service C (513) would be consumed by service A (511), and one unit of service B (512) would also be consumed by service A (511). It should, however, be understood that if, for instance, two units of service B (512) are consumed by service A (511), the matrix coefficients would be two instead of one. In addition, the matrix coefficients may be normalized to particular units of each of the matrix elements. Moreover, one unit of final demand (Y₁) (518) is made for service A (511).

As shown in FIG. 5C, the matrix coefficient (Z₂₁) (520) for a service produced by service B (521) and consumed by service A (522) is listed as a “1”, the matrix coefficient (Z₃₁) (523) for a service produced by service C (524) and consumed by service A (522) is listed as a “1”, the matrix coefficient (Zₙ₂) (525) for a service produced by service D (526) and consumed by service B (521) is listed as a “1”, the matrix coefficient (Zₙ₃) (527) for a service produced by service D (526) and consumed by service C (524) is listed as a “1”, and the remaining matrix coefficients are listed as “0's”. The matrix elements therefore denotes that service A (522) is dependent upon services B and C (521, 524) and that services B and C (521, 524) are dependent upon service D (526). In addition, the matrix elements indicates that one unit of demand for service A (522) has been made.

With reference back to FIG. 5B, given the matrix of elements (517), including a final demand vector (Y=Y₁, . . . , Yₙ), the total production of a service may be represented by a total output vector (X) (519). The final demand vector (518) may be a summary of the demand by end users for the various services in the services ecosystem. The total output vector (X) (519) may be determined from the following equation:

x₁=z₁₁+z₁₂+z₁₃+ . . . +z₁ₙ+y₁ Equation (1)

For calculation purposes, Equation (1) may be generalized by assuming that the flows between services are represented as a percentage of service output. This flow is represented by dividing the flow from service i to service j by the total output of service j. Thus, the inter-service flow may be represented as follows:

aᵢⱼ=zᵢⱼ/xⱼ,

where aᵢⱼ is a unitless technical coefficient that ranges in value from 0 to 1. As such, Equation (1) may be rewritten as:

x₁=aᵢ₁x₁+a₁₂x₁₂+ . . . aᵢₙxₙ+y₁ Equation (2)

Let the matrix A contain all of the technical coefficients (aᵢⱼ terms), vector X all the output (xᵢ) terms, and vector Y all the y terms, then:

X−AX=[I−A]x=Y, or X=[I−A]⁻¹Y Equation (3)

A decomposition of the general n×n form [I−A]⁻¹ gives:

X=Y+AY+A²Y+A³Y+ . . . +AⁿY Equation (4)

Equation (4) provides a method of evaluating, for a given demand of a single service, how much dependent resources across the entire services supply chain may be needed. In this regard, Equation (4) may be implemented to estimate the metric related to the service demand based upon the determined dependencies in the matrix of elements.

Once the output for each service (x) has been determined, a vector of a metric, such as direct environmental outputs, related to each service may then be obtained by multiplying the output at each stage by the metric per service unit according to the following equation:

bₙ=RₙX, or bₙ=Rₙ(I−A)⁻¹Y Equation (5)

In Equation (5), bn is a vector of a metric, such as environmental impact (for instance, toxic emissions, electricity use, water use, etc.), price, cost, or other metric, for each service unit, Rₙ is a matrix with diagonal elements representing the impact per service unit of output at each stage, and the subscript n represents a particular type of metric (for instance, environmental impact (electricity, toxic emissions, etc.), price, cost, or other metric.

### Statistical Approach

One approach for computing the service sustainability relationship for the service providers may include selecting service providers from the service class, and then receiving a report from each of the selected service providers. Each of the service provides may include in their reports various characteristics, such as value characteristics and cost characteristics. For example, the value characteristics may include a number of users of the service, Quality of Service (QoS), or scalability. The cost characteristic may include economic costs and ecological costs such as carbon emission, water usage, resource usage, other cost characteristics, or combinations thereof.

The report may include electronic service questionnaires. A processor may be programmed to compile a list of the characteristics reported in the questionnaires. The processor may use a common Service Description Language (SDL) to facilitate electronic data transfer between the service providers and a service evaluator program in communication with the processor. In some examples, the processor electronically transfers the service questionnaire from the service evaluator program to the selected service providers. Next, the service providers may send the reports back electronically. An aim of the method may be to gather sufficient data to ultimately establish a service sustainability relationship for the service providers.

For example, the questionnaire may be generated for an email service and include sufficient metrics to derive the value of the email service and the cost of the email service. The completed report may include detailed information such as how many users the email service supports, the average size of each email account, the number of servers, storage size and bandwidth as well as the cooling energy consumption of the data center hosting the service.

After the electronic service reports are received from the selected service providers, the service evaluator program may select at least one common value characteristic and at least one common cost characteristic which is common among each of the service providers within the service class. Examples of common value characteristics reported by each of the email service providers may include a number of users, the amount of storage allotted to each user, or a Quality of Service metric such as delivery time. Correspondingly, a common cost characteristic reported by each of the email service providers may include the average cost to deliver the email service such as economic cost in dollars or ecological cost in terms of carbon emission, water use, or other resource consumption. Once the common cost and value characteristics of the service providers are identified, a service sustainability relationship may be computed for the selected service providers. The relationship may be expressed as a function of at least one common value characteristic and at least one common cost characteristic.

Computing of the service value relationship may include determining if more than one common value characteristic exists, and if not, then computing a service value relationship for the service class as a function of the common value characteristic. Then determining if more than one common cost characteristic exists, and if not then computing a service cost relationship for the service class as a function of the common cost characteristic. A variety of equations or relationships can be utilized to estimate or generate the service cost relationship and the service value relationship. However, the relationship may be computed based on the commonly occurring cost and value characteristics that are published by each of the service providers. In the situation where multiple value characteristics are identified, the method may proceed by selecting a number of common value characteristics each of which is common among each of the service providers and assigning a weight to each of the common value characteristics. Thus, generating the service value relationship and the service cost relationship may include consolidating different cost and value definitions published by various service providers such that the service costs and service values can be normalized into a single metric for each service provider that may be used to compute the service sustainability relationship for the service class.

Once the service value relationship and the service cost relationship have been generated, the service sustainability relationships may be computed as a function of the ratio of the customer value derived from the service to the cost needed to provide the service. The service evaluator program may sequentially rank the service sustainability values associated with the selected service providers to benchmark the sustainability of each of the selected service providers relative to one another. Accordingly, a single value representing the service sustainability for each of the selected service providers may be derived for simplicity by benchmarking service sustainability among service providers using the single sustainability metric.

In some examples, a statistical approach is performed from the perspective of the user. In some examples, the metric values are calculated with a function that statistically evaluates the weights respectively assigned to the plurality of metrics and the acquired values of the plurality of metrics. According to an example, a metric value (I) for the user is calculated through the calculation of:

I=w₁*I₁+w₂*I₂+ . . . +wₙ*Iₙ

in which I₁, I₂ . . . , Iₙ are the plurality of metrics and w₁, w₂, . . . , wₙ are weighting coefficients corresponding to the weights that a user has respectively assigned to each of the plurality of metrics I₁, I₂ . . . , Iₙ. In addition, n is the total number of the metrics corresponding to the services. In addition, or alternatively, n is the total number of metrics that are to be used in assessing the service.

According to an example, each of the metric values I₁, I₂ . . . , Iₙ in the above equation may be normalized to enable the terms to be summed together. The metric values I₁, I₂ . . . , Iₙ may be normalized in any suitable manner to enable each of the metric values to have the same units.

By way of example, a user may care about just carbon emissions and not about any other metric. For this user, w₁=1 and (w₂, . . . wₙ)=0. As another example, another user may care equally about water use and carbon emissions, and not about anything else. For this user, w₁=0.5 and w₂=0.5 and (w₃, . . . , wₙ)=0. As a further example, another user may care equally about all the metrics. For this user, the weightings for each coefficient Wᵢ=1/n.

In some examples, the service-level metric value for the service may be used to compare the service with other services. In this example, the method may be implemented to calculate the metric values of a plurality of services such as the services in a particular class of services. In other examples, the metric values are compared with each other to determine which of the services best correlates with the metrics specified by a particular user or to a group of users. As a consequence, even though a particular service may generally have a higher metric value that value may change when individual user weights are considered.

FIG. 6 is a diagram of an illustrative method (600) for recommending options, according to principles described herein. In this example, the method (600) includes identifying (601) multiple end to end service delivery options where each of the options include a kind of service, an application service provider, and a client device to receive the kind of service; determining (602) a sustainability value for each of the end to end service delivery options; and recommending (603) one of the end to end service delivery options based on the sustainability value.

In some examples, the sustainability value includes at least one sustainability metric associated with each of the end to end service delivery options selected from the following group of electrical power consumption, water consumption, carbon dioxide emissions, natural resource consumption, rare earth metal consumption, and combinations thereof. In some examples, the service kinds include emailing, texting, social networking, blogging, instant messaging, video chatting, voice chatting, other service kinds, and combinations thereof.

Determining the sustainability values may include calculating a sustainability sub-value based on infrastructure used to execute each of the end to end service delivery options, calculating a sustainability sub-value based on a communication mechanism between the application service provider and the client device for each of the end to end service delivery options, and calculating a sustainability sub-value based on the client device. In some examples, determining the sustainability value includes combining multiple sustainability sub-values calculated for different components of the end to end service delivery options to calculate the sustainability value. In some examples, sustainability sub-values are determined for network infrastructure, service classes, communication mechanism, other option components, and combinations thereof.

The sustainability sub-values may be determined using matrix approaches, statistical approaches, modeling approaches, other approaches, or combinations thereof. In some examples, the sustainability sub-values and the overall sustainability values are determined with a processor or other computer program product. The determination may be performed online or may be performed on the client device. In some examples, the user inputs information into a field to aid the determination. In some examples, some of the data used to make the calculations is retrieved from online sources.

In some examples, the users may specify that some sustainability parameters should be more heavily weighted than other parameters. Further, in some examples, the users may specify that certain sustainability sub-values for the different option components are more heavily weighted than others.

In some examples, recommending one of the end to end service delivery options includes making a recommendation based on a sustainability value and based on a user specified parameter. In some examples, the recommendation is based on more than one specified parameter. The recommendation may be sent to a client device where an end user may view the recommendation. In some examples, an internet service provider receives the same recommendation that was sent to the user. In such an example, the internet service provider may use those recommendations to understand the sustainability goals and preferences of its users. In some examples, the internet service provider receives recommendations based on preferences that it specified. In some examples, the internet service provider's recommendation is based on a natural resource cost to the internet service provider. The natural resource cost may include the cost of the natural resources consumed during the operation of the services provided by the internet service provider. In some examples, the internet service provider uses the recommendations to understand which end to end service delivery options are more sustainable and to encourage the end user to use the more sustainable options.

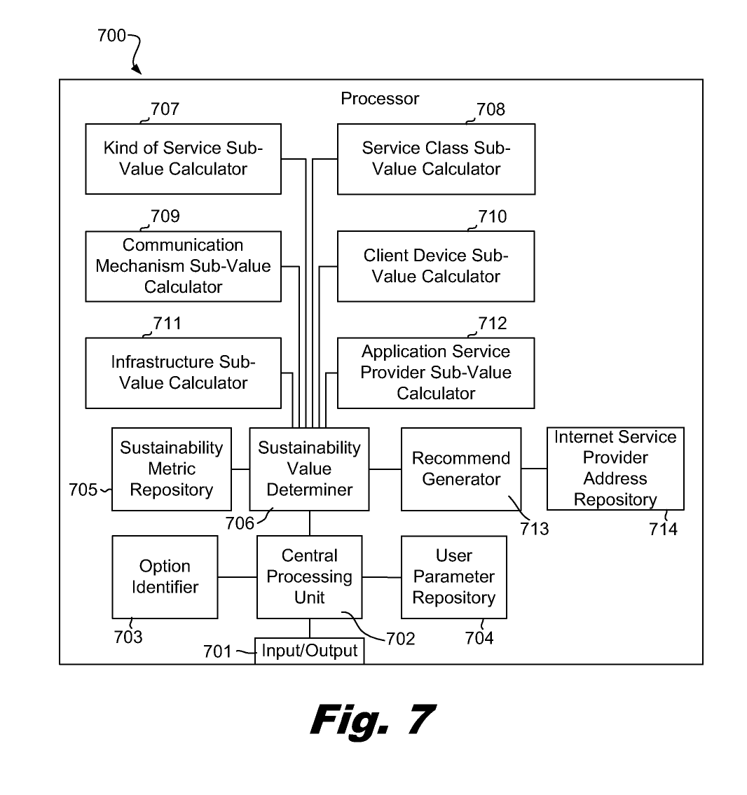

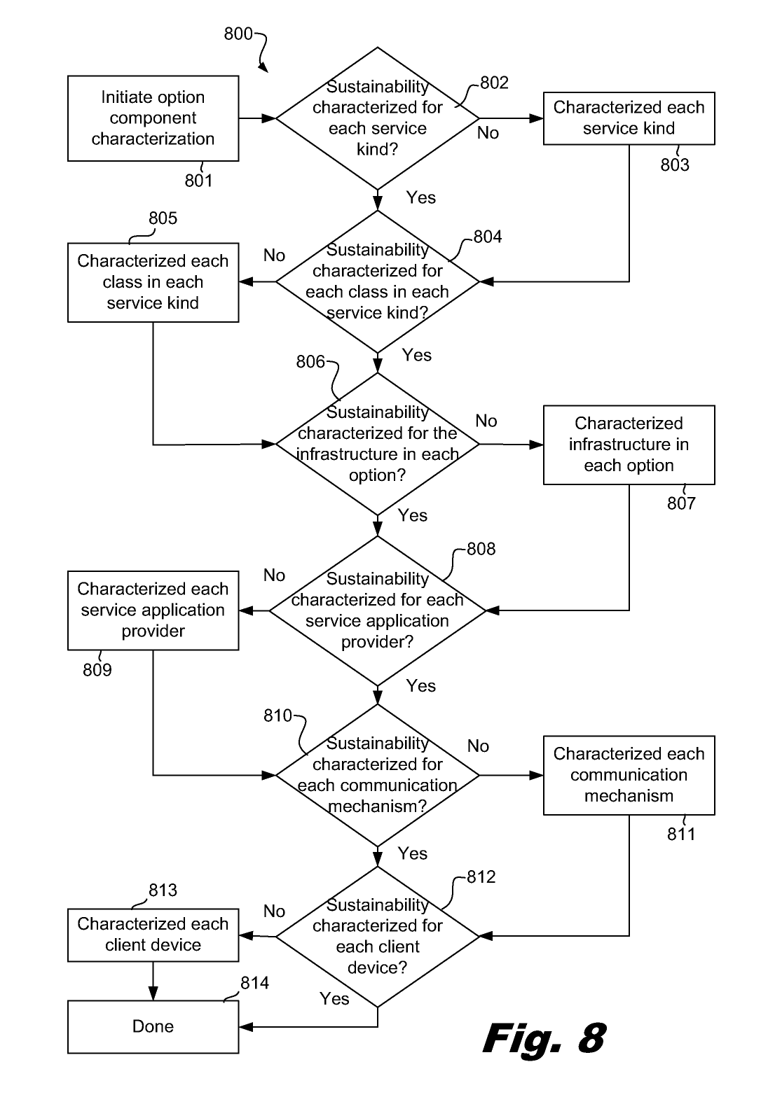

FIG. 7 is a diagram of an illustrative processor (700), according to principles described herein. In this example, the processor (700) includes an input/output (701) in communication with a central processing unit (CPU) (702). The CPU (702) is in communication with an option identifier (703) that may identify end to end service delivery options. In some examples, the option identifier (703) uses inputs from a user to identify the end to end service delivery options. In some examples, the option identifier (703) identifies options from an internal repository or an online resource. In some examples, a user specifies the task that the user wants to accomplish, and the option identifier (703) searches for end to end service delivery options capable of accomplishing that task.

In some examples, the user also specifies sustainability parameters, which may be stored in a user parameter repository (704). In some examples, the user specifies which parameters should be considered when making a recommendation. In some examples, the user has an ability to indicate sustainability thresholds. For example, the user may indicate that the user does not want to use an option that consumes more than a specific amount of water per each execution of the service.

A sustainability metric repository (705) may include pre-identified sustainability metrics from which the user may select sustainability parameters. In some examples, the user may specify additional parameters to be considered. For example, if the user becomes concerned about emissions of a specific gas that a government organization recently begins to regulate, the user may input the new gas into a field of a user interface. The processor (700) may add the new sustainability metric into the sustainability metric repository (705) for current and future processing. In some examples, the processor (700) searches online resources to determine information about the new sustainability metric to aid in determining sustainability values.

The sustainability metric repository (705) may be in communication with a sustainability value determiner (706) that determines the overall sustainability value per end to end service delivery option. In some examples, the sustainability value determiner (706) requests sustainability sub-value calculations for each component of each of the end to end service delivery options. In the example of FIG. 7, the sustainability value determiner (706) is in communication with a kind of service sub-value calculator (707), a service class sub-value calculator (708), a communication mechanism sub-value calculator (709), a client device sub-value calculator (710), an infrastructure sub-value calculator (711), and an application service provider sub-value calculator (712). In some examples, the sustainability value determiner (706) requests calculations for just the sub-values associated with preferences identified by the user to be included in the sustainability value.

The CPU (702) may also be in communication with a recommend generator (713) that may send a recommendation to a user and to an internet service provider. The recommendation made to the internet service provider may have the same information or different information than the information in the recommendation to the user. In some examples, the recommend generator (713) is in communication with an internet service provider address repository (714) that contains an address of the internet service provider.

FIG. 8 is a diagram of an illustrative flowchart (800) of a process for determining sustainability values, according to principles described herein. In this examples, the process includes initiating (801) option component characterization. Characterizing the sustainability may include gathering the information needed to calculate a sustainability sub-value. In some examples, the information includes determining the amount of water, power, or other resource consumption; determining an amount of carbon dioxide or other gas emission; determining other factors needed to carry out the calculations under a matrix approach, a statistical approach, modeling approach, or other approach; determining other factors, and combinations thereof.

The process may include determining (802) whether the sustainability is characterized for each kind of service. If each kind of service has not been characterized, then the process may include characterizing (803) each kind of service. The process may also include determining (804) whether the sustainability is characterized for each class in each kind of service. If each class has not been characterized, then the process may include characterizing (805) each class.

The process may also include determining (806) whether the sustainability is characterized for the infrastructure in each option. If the infrastructure has not been characterized, then the process may include characterizing (807) the infrastructure in each option. The process may also include determining (808) whether the sustainability is characterized for each service application provider in each option. If each application service provider has not been characterized, then the process may include characterizing (809) each service application provider in each option.

The process may also include determining (810) whether the sustainability is characterized for each communication mechanism in each option. If each communication mechanism has not been characterized, then the process may include characterizing (811) each communication mechanism in each option. The process may also include determining (812) whether the sustainability is characterized for each client device in each option. If each client device has not been characterized, then the process may include characterizing (813) each client device in each option.

In the example of FIG. 8, when each of the components of the end to end service delivery options are characterized, the process is finished (814). The characterizations may be used to determine the sub-values of each component of each option.

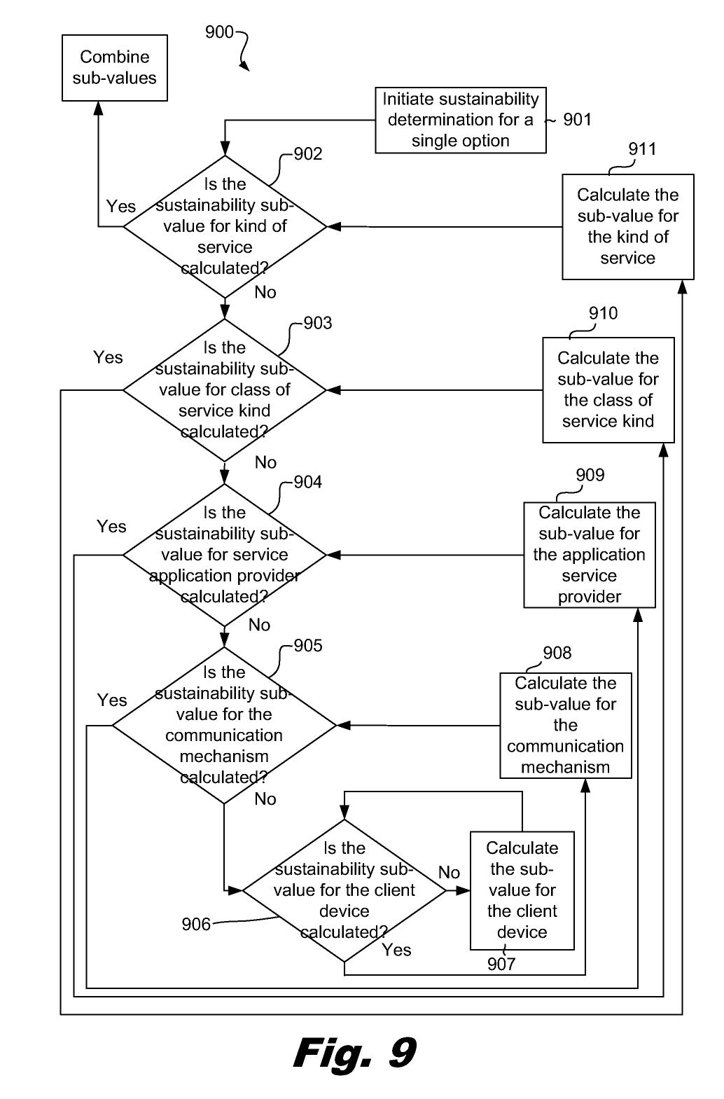

FIG. 9 is a diagram of an illustrative flowchart (900) of a process for determining sustainability values for a single option, according to principles described herein. In this example, the process includes initiating (901) the sustainability determination for a single end to end service delivery option. In FIG. 9, the process includes determining (902) whether the sustainability sub-value for the kind of service is calculated. If not, the process may include determining (903) whether the sustainability sub-value for the class of the service kind is calculated. If not, the process may include determining (904) whether the sustainability sub-value for the application service provider is calculated. If not, the process may include determining (905) whether the sustainability sub-value for the communication mechanism is calculated. If not, the process may include determining (906) whether the sustainability sub-value for the client device is calculated.

If the sustainability sub-value for the client device is not calculated, the process may include calculating (907) the sustainability sub-value for the client device and then determining (906) whether the sustainability sub-value for the client device is calculated. If the sustainability sub-value for the client device is calculated, then the process may include calculating (908) the sustainability sub-value for the communication mechanism and then determining (905) whether the sustainability sub-value for the communication mechanism is calculated. If the sustainability sub-value for the communication mechanism is calculated, then the process may include calculating (909) the sustainability sub-value for the application service provider and then determining (904) whether the sustainability sub-value for the application service provider is calculated. If the sustainability sub-value for the application service provider is calculated, then the process may include calculating (910) the sustainability sub-value for the service class and then determining (903) whether the sustainability sub-value for the service class is calculated. If the sustainability sub-value for the service class is calculated, then the process may include calculating (911) the sustainability sub-value for the kind of service and then determining (902) whether the sustainability sub-value for the kind of service is calculated.

If the sustainability sub-value for the kind of service is calculated, then the process may include combining (912) the sub-values from the other option components to determine the overall sustainability value for the entire end to end service delivery option. The process may be rerun on the other end to end service delivery options until all of the sustainability values have been determined for each of the options.

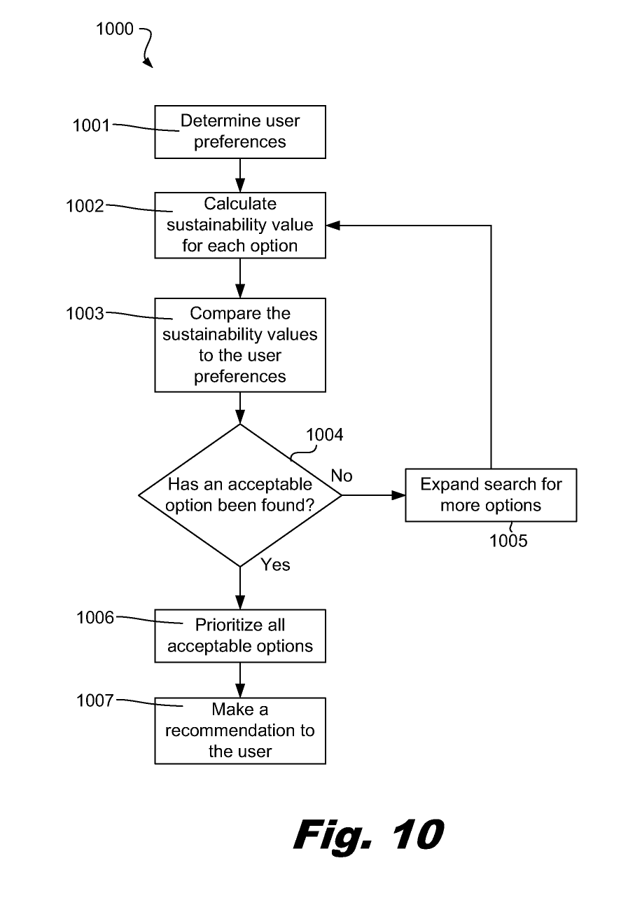

FIG. 10 is a diagram of an illustrative flowchart (1000) of a process for recommending options, according to principles described herein. In this example, the process includes determining (1001) user preferences. In some examples, the user preferences are determined when a user inputs his preferences into a field of a user interface. The process also includes calculating (1002) the sustainability value for each option and comparing (1003) the sustainability values to the user preferences.

The process may also include determining (1004) whether any of the options with determined sustainability values have been found that match the user's preference. In no such options have been found, then the process may include expanding (1005) the search to include more options and calculating (1002) sustainability values for those options.

When at least one option that is suitable according to the user's preferences is found, the process may include prioritizing (1006) all of the acceptable options. Further, the process may include making (1007) a recommendation to the user based on the results of the process. In some examples, the options with the highest sustainability value are ranked the highest, and the recommendation encourages the user to use the option with the highest recommendation value.

In some examples, the sustainability value includes a single metric such as a scalar number that incorporates the parameters weighed as indicated by the users. In other examples, the sustainability value includes multiple metrics. For example, the sustainability value may include a ratio of sustainability to the cost to the user.

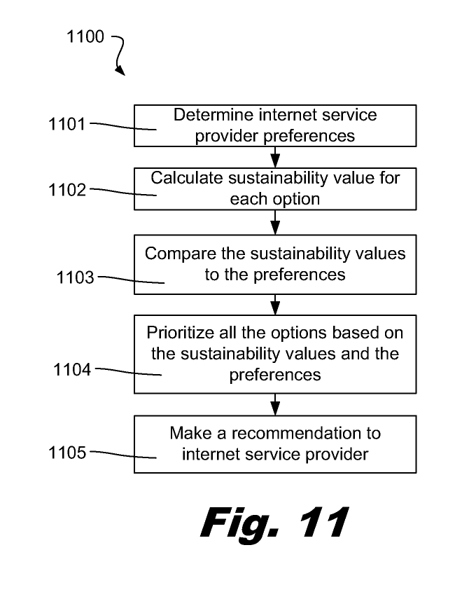

FIG. 11 is a diagram of an illustrative method (1100) for recommending options, according to principles described herein. In this example, the method (1100) includes determining (1101) an internet service provider's preferences. The preferences may be determined based on user input through a user interface. In other examples, the input is determined with a set of parameters internal to a computer program executing the method.

The method may also include calculating (1102) a sustainability value for each of the end to end service delivery options and comparing (1103) the sustainability sub-values to the internet service provider's preferences. In the example of FIG. 11, the method includes prioritizing (1104) all of the options based on the sustainability values and the preferences. The method (1100) may also include making (1105) a recommendation to the internet service provider based on the sustainability values and the preferences.

In some examples, the internet service provider uses the information in the recommendation to determine which options are the most sustainable and/or cost effective for its customers to use. In some examples, the internet service provider uses the information to provide incentives to customers to use those end to end service delivery options that are most sustainable and/or cost effective to the internet service provider. The internet service provider may provide the incentives through cutting costs on certain products, offering specials to use certain options when customers sign up as customers, other mechanisms to provide incentives, and combinations thereof.

While the examples above have been described with services related to sending a message, the principles described herein may be applied to other services such as sending pictures, word processing, document interpretation, information searches, web searches, video watching, online shopping, obtaining driving directions, calendaring, document editing, internet alerting, stock trading, database services, digital storage services, engineering services, art services, financial services, education services, other services, or combinations thereof. In some examples, some of the end to end service delivery options that include the services mentioned above also include service classes and application service providers.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for recommending options based on sustainability metrics, comprising:
identifying multiple end to end service delivery options, each of said end to end service delivery options comprising a kind of service, an application service provider to provide said kind of service, and a client device to receive said kind of service;
determining a sustainability value for each of said end to end service delivery options; and
recommending one of said end to end service delivery options based on said sustainability value.

2. The method of claim 1, where said sustainability value comprises at least one sustainability metric associated with each of said end to end service delivery options selected from a group of resource use, water use, gas use, electricity use, natural resource consumption, raw metal consumption, mineral consumption, rare earth consumption, conflict mineral consumption, emissions, greenhouse gas emissions, ozone depletion agents emissions, sulfur dioxide emissions, air pollutant emissions, particulate emissions, toxic effluents emissions, land use, and combinations thereof.

3. The method of claim 1, wherein said kinds of services are selected from a group consisting of emailing, texting, social networking, blogging, instant messaging, video chatting, voice chatting, and combinations thereof.

4. The method of claim 1, wherein recommending one of said end to end service delivery options includes making a recommendation based on said sustainability value and based on a user specified parameter.

5. The method of claim 1, wherein recommending one of said end to end service delivery options includes sending a recommendation based on said sustainability value and based on a natural resource cost to an internet service provider.

6. The method of claim 1, wherein determining a sustainability value for each of said end to end service delivery options includes calculating a sustainability sub-value based on infrastructure used to execute each of said end to end service delivery options.

7. The method of claim 1, wherein determining a sustainability value for each of said end to end service delivery options includes calculating a sustainability sub-value based on a communication mechanism between said application service provider and said client device for each of said end to end service delivery options.

8. The method of claim 1, wherein determining a sustainability value for each of said end to end service delivery options includes calculating a sustainability sub-value based on said client device.

9. The method of claim 1, wherein determining a sustainability value for each of said end to end service delivery options includes determining multiple sustainability sub-values for different components of said end to end service delivery options with a different approach.

10. A computer program product for recommending options based on sustainability metrics, comprising:
a tangible computer readable storage medium, said computer readable storage medium comprising computer readable program code embodied therewith, said computer readable program code comprising:
computer readable program code to identify multiple end to end service delivery options, each of said end to end service delivery options comprising a kind of service, an application service provider to provide said kind of service, and a client device to receive said kind of service;
computer readable program code to calculate multiple sustainability sub-values for different components for each of said end to end service delivery options with a different approach;
computer readable program code to combine said sustainability sub-values to determine an overall sustainability value for each of said end to end service delivery options; and
computer readable program code to recommend one of said end to end service delivery options based on said overall sustainability value.

11. The computer program product of claim 10, further comprising computer readable program code to calculate a sustainability sub-value based on infrastructure used to execute each of said end to end service delivery options.

12. The computer program product of claim 10, further comprising computer readable program code to calculate a sustainability sub-value based on a communication mechanism between said application service provider and said client device for each of said end to end service delivery options.

13. The computer program product of claim 10, further comprising computer readable program code to calculate a sustainability sub-value based on said client device in each of said end to end service delivery options.

14. A system for recommending options based on sustainability metrics, comprising:
a processor programmed to
identify multiple end to end service delivery options, each of said end to end service delivery options comprising a kind of service, an application service provider to provide said kind of service, and a client device to receive said kind of service;
calculate multiple sustainability sub-values for different components for each of said end to end service delivery options with multiple approaches;
combine said sustainability sub-values to determine an overall sustainability value; and
recommend one of said end to end service delivery options based on said overall sustainability value and based on a user specified parameter.

15. The system of claim 14, wherein said processor is further programmed to recommend one of said end to end service delivery options based on a natural resource cost to an internet service provider.
